(19) United States
(12) Patent Application Publication
(10) Pub. No.: US 2007/0177580 A1
(43) Pub. Date: Aug. 2, 2007

(54) IP multimedia subsystem communications for a variety of devices

(76) Inventors: Andrew G. Ragona, Marlton, NJ (US); Daniel S. Stoops, Galena, OH (US)

Correspondence Address: CARLSON, GASKEY & OLDS, P.C., 400 W MAPLE RD, SUITE 350, BIRMINGHAM, MI, 48009, US

(21) Appl. No.: 11/343,903

(22) Filed: Jan. 31, 2006

(51) Int. Cl. H04L 12/66; H04J 3/16

(52) U.S. Cl. 370/352; 370/466

(57) ABSTRACT

A communication system (20) includes a message mediator (50) that converts between an IP multimedia subsystem (IMS) protocol and a second, different protocol to facilitate communications between a first user device (26) having an IMS capacity or resident IMS client (28) and a second user device (30-40) that does not have IMS capacity. In a disclosed example, the message mediator acts as a centralized IMS client on behalf of a variety of devices not having their own IMS capacity. In one example, the user of a first device may instigate an IMS based communication among two other devices through the message mediator. The message mediator also provides presence information regarding individuals or devices active on the IMS network 22.

### FIELD OF THE INVENTION

This invention generally relates to communications. More particularly, this invention relates to using an IP Multimedia Subsystem protocol for communications.

### DESCRIPTION OF THE RELATED ART

There are a variety of communication techniques and formats available. Examples include circuit switched calls or traditional phone calls, wireless communications using cell phones, internet communications, e-mail communications, voice over internet protocol communications and instant message communications. Each type of communication typically has its own format or protocol and associated requirements. A device that is capable of communicating using one of the protocols or formats typically has dedicated hardware, software or both that facilitates communications using the particular protocol or format.

For example, some cell phones are capable of communicating using voice communications, data communications in an HTML format and instant message communications using an IP multimedia subsystem (IMS) protocol. Such mobile stations may be a cell phone or a personal digital assistant, for example. In such cases, there is dedicated hardware, software or both for the various types of communications.

In the case of IMS communications, capable devices have an IMS client that communicates with an IMS application server to communicate utilizing an IMS network. Each individual desiring to communicate using the IMS protocol (for instant messaging, for example) must have a device with an IMS client capable of interfacing with an IMS application server or another appropriate portion of the IMS network.

It would be beneficial to be able to expand the use of IMS services beyond devices having a dedicated IMS client. This invention provides the ability to do that.

### SUMMARY OF THE INVENTION

An exemplary method of communicating includes using a message mediator to convert a communication between an IP multimedia subsystem (IMS) protocol and a second, different protocol to facilitate communications between a first user device having an IMS capacity and a second user device that does not have an IMS capacity.

In one example, the message mediator receives a communication using the IMS protocol. The message mediator converts the received communication into one using the second, different protocol and transmits the converted communication. In this example, a first user device having IMS capacity can communicate using that protocol with another device that is otherwise not capable of supporting that protocol without the intervention of the message mediator.

One example includes receiving an instruction at the message mediator from a user device that does not have IMS capacity regarding a desired communication between two other devices having IMS capacity. The message mediator automatically instigates the desired communication between the other user devices responsive to the received instruction.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows an example system for communicating between user devices that are capable of communicating in different formats.

FIG. 2 schematically illustrates one example feature of a message mediator useful with an embodiment of this invention.

FIG. 3 schematically illustrates another example feature of an example message mediator useful in an embodiment of this invention.

FIG. 4 schematically illustrates another example feature of a message mediator useful with an embodiment of this invention.

### DETAILED DESCRIPTION

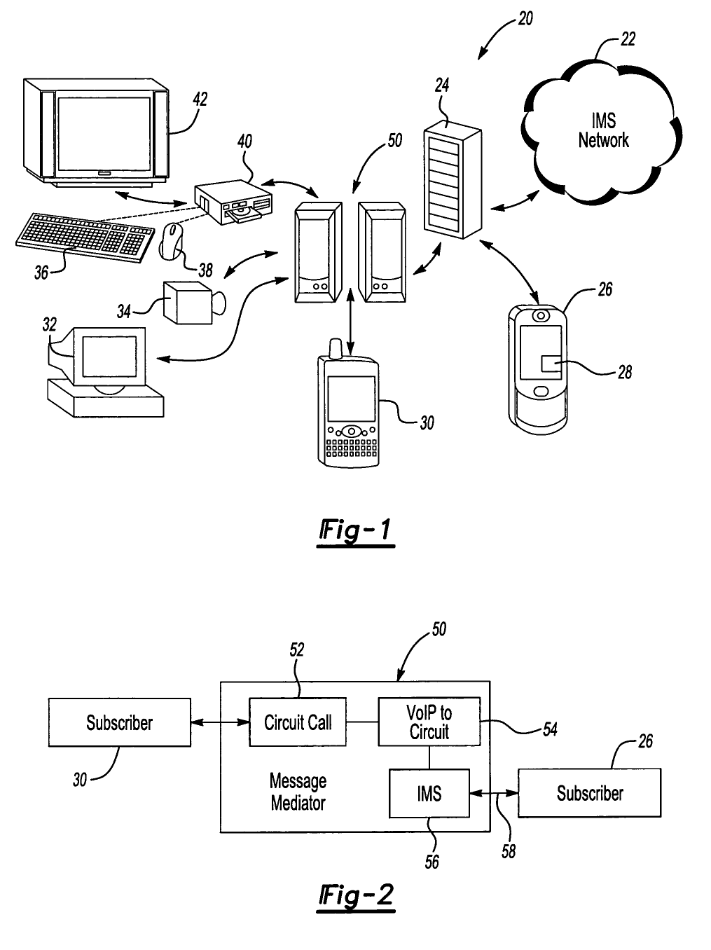

FIG. 1 schematically shows a communication system 20 that allows for various types of communications between and among various types of communication devices. An IP multimedia subsystem (IMS) network 22 facilitates communications using an IMS protocol in a known manner. In this example, an IMS application server 24 facilitates access to the IMS network 22 on behalf of at least a first user device 26. In this example, the first user device 26 comprises a mobile station such as a cell phone. In this example, the first user device 26 includes an IMS client 28 (e.g., hardware, software or both) that provides an IMS capacity for the first user device 26. The presence of the IMS client 28 on the first user device 26 allows for direct communication with the IMS application server 24 to use IMS communications in a known manner.

The system 20 shown in FIG. 1 also includes a plurality of other communication devices that do not have an IMS capacity. A variety of example second user devices without IMS capacity are illustrated. A mobile station 30 such as a cell phone or personal digital assistant is capable of a circuit switched voice call in a known format, for example. A computer 32 is capable of wireless or line-based communications using an HTTP format, for example. A video recorder 34 is capable of data communications, for example. Input devices such as a keyboard or a pointer 38 in this example communicate with a processor within a so-called set top box 40 that is normally associated with viewing televised programming on a television display 42.

Each of the example second user devices that do not have an IMS client and, therefore, do not have their own IMS capacity can communicate with a message mediator 50 that facilitates communications between such devices and the IMS network 22. In this example, the message mediator 50 acts as a centralized IMS client on behalf of all of the example devices 30-40 provided that such devices are capable of communicating in at least one format or using at least one protocol that is recognized by the message mediator 50.

In one example, the message mediator 50 has known capabilities for receiving and transmitting communications using a variety of protocols to support HTTP communications, HTML communications, CDMA and UTMS communication protocols, for example. The message mediator 50 is capable of communicating with a variety of devices using a protocol that is recognized by the message mediator and supported by the particular device.

The example message mediator 50 comprises an IMS client that can communicate with the IMS application server 24 to facilitate communications between any one or all of the second user devices 30-40 and the first user device 26, for example. The message mediator 50 converts communications between an IMS protocol and a second, different protocol supported by one or more of the second user devices 30-40 to facilitate IMS communications between the first user device 26 and at least one of the second user devices 30-40.

FIG. 2 schematically illustrates one technique used by an example message mediator 50. In this example, the second user device 30 comprises a cell phone that utilizes a circuit call protocol to initiate a communication with the IMS capable first user device 26. In this example, a circuit call handling module 52 within the message mediator 50 communicates directly with the mobile station or second user device 30. A conversion module 54 converts the circuit call protocol to a voice over Internet protocol (VoIP), which can then be translated to an IMS protocol for use by the IMS client 56 resident at the message mediator 50. IMS communications can then be accomplished using the IMS application server 24, the IMS network 22 or both for communicating between the message mediator 50 and the first user device 26.

The communication links schematically shown at 58 in FIG. 2 comprise communications through one or more of the IMS application server 24 and the IMS network 22, depending on the needs of the particular situation.

As can be appreciated from this description, the example of FIG. 1 expands the possibilities for IMS communications to a variety of devices without requiring each such device to have a resident IMS client. This greatly expands the possibilities for expanding IMS communications without requiring individuals to update or replace existing communication devices. The message mediator 50, acting as a centralized IMS client, expands the possibility for communications using IMS among a wider variety of devices.

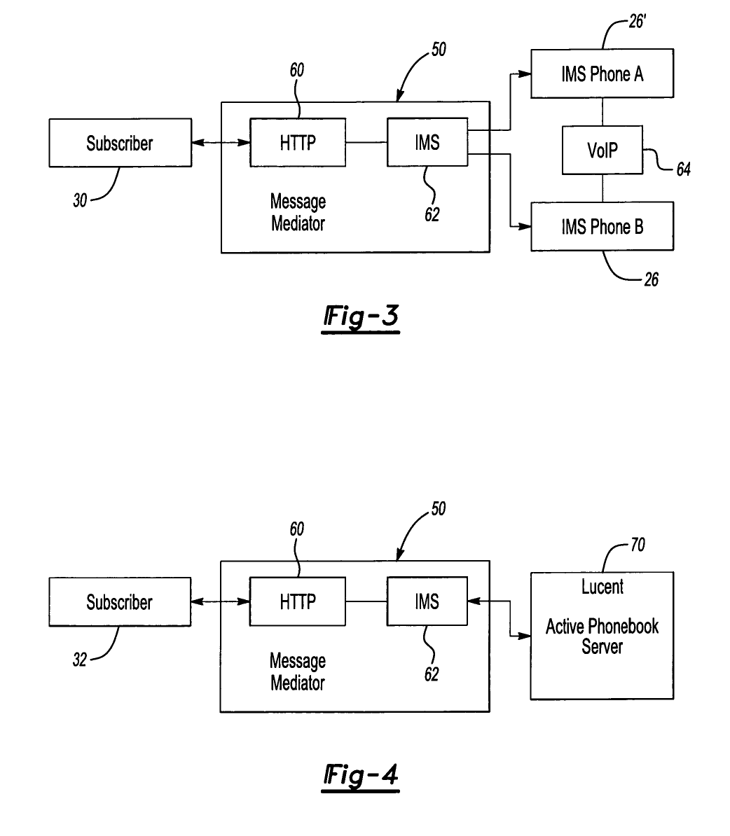

FIG. 3 schematically illustrates another feature of one example embodiment. In this example, the message mediator 50 is capable of instigating an IMS communication between two devices that have IMS capacity responsive to a command to instigate such a communication from another device that does not necessarily have IMS capacity. In the example of FIG. 3, the mobile station 30 is used to send an HTTP communication to the message mediator 50. An HTTP processing module 60 within the message mediator 50 receives that communication, which indicates a desired VoIP format communication between the first user device 26 and another, similarly configured user device 26′. In this example, an IMS client 62 resident at the message mediator 50 instigates a VoIP call schematically shown at 64 between the devices 26 and 26′. This example allows an individual to use one type of communication device and the message mediator 50 to instigate another type of communication between two other devices.

Another feature of an example message mediator 50 is schematically shown in FIG. 4. In this example, the message mediator 50 includes an HTTP communication module 60 for communicating with one of the second user devices such as the computer 32. In this example, the message mediator 50 allows an individual using the computer 32 to determine whether a device having IMS capacity is present or active on the IMS network 22 and available for IMS communications. In this example, the HTTP communication module 60 converts the communication from the computer 32 to an IMS protocol and the IMS client 62 interacts with an active phone book server 70, that provides an indication of the presence of at least one individual or device that is active on the IMS network 22. This example allows a subscriber who does not have a device with IMS capacity to detect the presence of other IMS capable devices through a HTTP webpage on the device without IMS capacity, for example. Communications between the message mediator 50 and the computer 32 in the example of FIG. 4 include a report in a format consistent with an HTTP webpage display on the computer 32, which provides an indication of the presence of the individual or device in question.

In one example, the message mediator 50 keeps track of identification information regarding any of the devices 30-40 that are utilizing the IMS client capacity of the message mediator 50. This information can be shared with other devices who are making presence inquiries so that the ability to determine who is available for IMS communications includes not only devices such as the first user device 26 but also other devices not having their own IMS capacity. In other words, this example makes it possible to detect the presence of those that are relying upon the message mediator 50 for IMS capacity.

Another example includes communications among a plurality of message mediators regarding such information. In one example, the IMS application server 24 is responsible for maintaining information regarding individuals or devices that are present and available for IMS communications. In such an example, the message mediator 50 provides information indicating a unique identification of each of the devices being served by the message mediator 50 so that individuals having IMS capable devices such as the first user device 26 can detect the presence of such other devices or individuals and their availability for IMS communications. Additionally, another message mediator serving a different device can inquire whether the message mediator 50 is serving a particular user.

The example system expands the possibilities for communications in a variety of formats among a variety of devices by including a message mediator that can serve as a centralized IMS client on behalf of devices that do not have a resident IMS client or IMS capacity.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
using a message mediator to convert a communication between an IP multimedia subsystem (IMS) protocol and a second, different protocol to facilitate communications between a first user device having an IMS capacity and a second user device that does not have an IMS capacity.

2. The method of claim 1, comprising
receiving a communication using the IMS protocol at the message mediator;
converting the received communication into the second, different protocol; and
transmitting the converted communication using the second, different protocol.

3. The method of claim 1, comprising
receiving a communication in the second, different protocol at the message mediator;
converting the received communication into the IMS protocol; and
transmitting the converted communication in the IMS protocol.

4. The method of claim 1, comprising
detecting a communication status of the first user device; and
using the message mediator to provide an indication regarding the detected communication status to the second user device.

5. The method of claim 1, comprising
receiving an instruction at the message mediator from the second user device regarding a desired communication between a third user device that has an IMS capacity and the first user device; and
using the message mediator to automatically instigate the desired communication between the third user device and the first user device.

6. The method of claim 5, comprising
communicating directly between the message mediator and at least the third user device to instigate the desired communication.

7. The method of claim 5, wherein the desired communication is a voice over Internet Protocol call.

8. The method of claim 1, wherein the IMS capacity of the first user device comprises an IMS client resident on the first user device.

9. The method of claim 1, comprising using the message mediator as an IMS client on behalf of a plurality of second user devices that do not have a resident IMS client.

10. A device for facilitating communications between at least one first user device having an IP multimedia subsystem (IMS) capability and at least one second user device that does not have an IMS capability, comprising
a message mediator that converts a communication between an IMS protocol and a second, different protocol such that the first and second user devices can communicate using the IMS protocol.

11. The device of claim 10, wherein the message mediator comprises an IMS client that is operative on behalf of the at least one second user device.

12. The device of claim 10, wherein the message mediator comprises a circuit call handling module; and
a conversion module that converts between a circuit call protocol and the IMS protocol.

13. The device of claim 12, wherein the conversion module converts the circuit call protocol to a voice over internet protocol and between the voice over internet protocol and the IMS protocol.

14. The device of claim 10, comprising
a processing module that receives an indication from a first station indicating a desired communication between a second and a third station in one of an IMS protocol or a voice over internet protocol; and
the message mediator instigates the desired communication between the second and third stations using the desired protocol.

15. The device of claim 10, wherein the message mediator provides information regarding an availability of at least one user for communication using the IMS protocol.
